(19) United States
(12) Patent Application Publication
(10) Pub. No.: US 2022/0316725 A1
(43) Pub. Date: Oct. 6, 2022

(54) AIR-CIRCULATING CONFERENCE TABLE

(71) Applicant: CoStar Realty Information, Inc., Washington, DC (US)

(72) Inventor: Andrew C. Florance, San Francisco, CA (US)

(21) Appl. No.: 17/710,232

(22) Filed: Mar. 31, 2022

Related U.S. Application Data
(60) Provisional application No. 63/168,375, filed on Mar. 31, 2021.

(51) Int. Cl. F24F 7/003; F24F 8/10; F24F 8/22; A47B 13/08; A47B 37/00

(52) U.S. Cl. CPC F24F 7/003; F24F 8/10; F24F 8/22; A47B 13/08; A47B 37/00; A47B 2220/0091

(57) ABSTRACT

A table for providing filtered air includes a table top defining a flat working surface, a table base provided vertically below the table top and defining an interior space therein, and at least one air filtration unit disposed in the interior space of the table base. The table top includes one or more air outlet nozzles that are disposed at the working surface and configured to discharge air in an upward direction. The table top also includes one or more air inlet vents that are disposed at the working surface and configured to receive air in a downward direction. The air filtration unit is configured to receive return air from the one or more air inlet vents and to discharge filtered air via the one or more air outlet nozzles.

### CROSS-REFERENCE TO RELATED APPLICATIONS

This application claims priority to U.S. Provisional Application Ser. No. 63/168,375, filed on Mar. 31, 2021, which is hereby incorporated by reference in its entirety.

### FIELD

The present application generally relates to a table for providing filtered air that

to one or more individuals using the table.

### BACKGROUND

During public health emergencies, such as pandemics, epidemics, or localized outbreaks, private and public institutions may implement certain social distancing requirements and/or policies that may affect the ability of working groups to work collaboratively. For example, in order to reduce the spread of airborne diseases (e.g., influenza, COVID-19, etc.), working groups may move to online platforms to conduct meetings remotely (i.e., working from home). Although remote meetings may eliminate the risk of aerosol spread, the lack of in-person communication between group members may negatively affect productivity, innovation, creative thinking, communication, and other areas of work performance.

Therefore, it would be advantageous to have an air-circulating conference table that reduces the risk of aerosol spread in order to facilitate safer in-person meetings during pandemics, epidemics, localized outbreaks, or other public health emergencies. Furthermore, air-circulating conference tables may be advantageously used to provide more sterile collaborative work environments outside of the above-described public health emergencies in order to contribute to a generally safer and more pleasant working environment by, among other things, reducing the presence of dusts and other pollutants in the air. While standalone air filtration units are widely available, such units are typically not designed to reduce transmission of airborne pathogens between people that may be seated adjacently at the same table, for instance. Such units can also be large and/or noisy, thus detracting from a comforting and collaborative working environment.

### SUMMARY

The present disclosure describes an air-circulating table that can help reduce the spread of airborne contaminants among users of the table by providing an integrated air filtration unit.

According to one aspect of the subject matter described in this application, a table for providing filtered air includes a table top defining a flat working surface, the table top including one or more air outlet nozzles that are disposed at the working surface and configured to discharge air in an upward direction and one or more air inlet vents that are disposed at the working surface and configured to receive air in a downward direction, a table base provided vertically below the table top and defining an interior space therein, and at least one air filtration unit disposed in the interior space of the table base, the air filtration unit being configured to receive return air from the one or more air inlet vents and to discharge filtered air via the one or more air outlet nozzles.

Implementations according to this aspect can include one or more of the following features. For example, the table may include a plurality of ducts in the interior space of the table base that provide fluid connection from the at least one air filtration unit to the one or more air outlet nozzles and to the one or more air inlet vents. The plurality of ducts may include an exhaust duct that connects an exhaust of the at least one air filtration unit to the one or more air outlet nozzles and an intake duct that connects an intake of the at least one air filtration unit to the one or more air inlet vents. In some cases, the one or more air inlet vents may include one or more edge vents that are disposed closer to an edge region of the table than the one or more air outlet nozzles, where the one or more edge vents may be positioned laterally outward beyond a lateral boundary of the table base. In some implementations, the intake duct may include an end portion that connects to the one or more edge vents, where the end portion of the intake duct may extend beyond the lateral boundary of the table base.

In some implementations, the table may further include at least one duct housing that extends laterally outward from the table base and protrudes vertically downward from a bottom surface of the table top, where each of the at least one duct housing may define an interior space that houses the end portion of the intake duct. The table may include at least two adjacent working areas for accommodating two adjacently seated users, and the at least one duct housing may be provided between the at least two adjacent working areas. In some cases, a laterally outermost surface of the at least one duct housing may be inclined downward toward the table base. At least one air filtration unit may include a fan and a filter. The filter may include a high-efficiency particulate air (HEPA) filter.

In some cases, the interior space of the table base may be at least partially defined by a bottom surface of the table top and an external wall of the table base. The external wall may include one or more side panels. At least one of the one or more side panels may be an access panel that is configured to be removed to thereby allow access to the at least one air filtration unit housed in the interior space. In some cases, the exhaust duct may connect the exhaust of the at least one air filtration unit to a plenum that is provided in the interior space of the table base, and the plenum may be configured to direct the filtered air received from the exhaust duct to the one or more air outlet nozzles. In some case, an ultraviolet (UV) light source configured to disinfect the air may be provided within the plenum. The plenum may be disposed between a bottom surface of the table top and a top surface of the at least one air filtration unit. Also, the plenum may be connected to two or more air outlet nozzles via additional ducts.

In some implementations, the one or more air inlet vents may include one or more center vents that are disposed farther from the edge region of the table than the one or more air outlet nozzles, and the intake duct may include a first intake duct that connects the intake of the at least one air filtration unit to the one or more air inlet vents and a second intake duct that connects the intake of the at least one air filtration unit to the one or more center vents. The one or more air outlet nozzles may be configured to output the filtered air in a direction that is vertically inclined with respect to the working surface. In some cases, the table may include at least two oppositely disposed working areas for accommodating two users seated on opposite sides of the table, where each of the at least two adjacent working areas may include at least one of the one or more air outlet nozzles. Additionally, the at least one air filtration unit may be disposed between the at least two oppositely disposed working areas.

The details of one or more implementations are set forth in the accompanying drawings and the description below. Other features and advantages will become apparent from the description, the drawings, and the claims.

### BRIEF DESCRIPTION OF THE DRAWINGS

FIG. 1 shows a top perspective view of an example air-circulating table.

FIG. 2 shows a bottom perspective view of the air-circulating table shown in FIG. 1.

FIG. 3 shows a top view of the example air-circulating table according to the present disclosure.

FIG. 4 shows a cross-sectional view of the air-circulating table shown in FIG. 1 along a lengthwise direction.

FIG. 5 shows a cross-sectional view of the air-circulating table shown in FIG. 1 along a widthwise direction.

FIG. 6 shows a cross-sectional view of another example air-circulating table along the widthwise direction.

FIG. 7 illustrates a user seated at the air-circulating table shown in FIG. 5.

FIG. 8 shows a close-up perspective view of a lower portion of the air-circulating table shown in FIG. 1.

FIGS. 9A and 9B show perspective views of an example outlet nozzle according to the present disclosure.

FIG. 10 illustrates an example conference room containing the air-circulating table shown in FIG. 1.

FIG. 11 shows an example controller interface for controlling the air-circulating table.

Like reference numbers and designations in the various drawings indicate like elements.

### DETAILED DESCRIPTION

In the following description, various working examples are provided for illustrative purposes. However, it is to be understood the present disclosure may be practiced without one or more of these details.

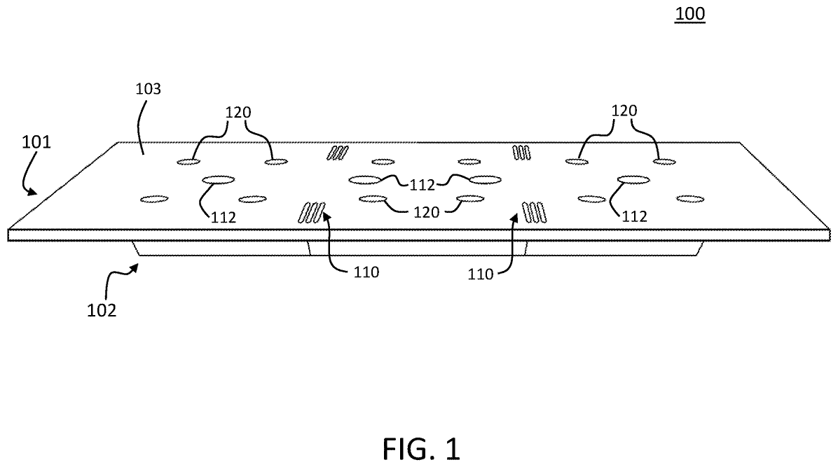

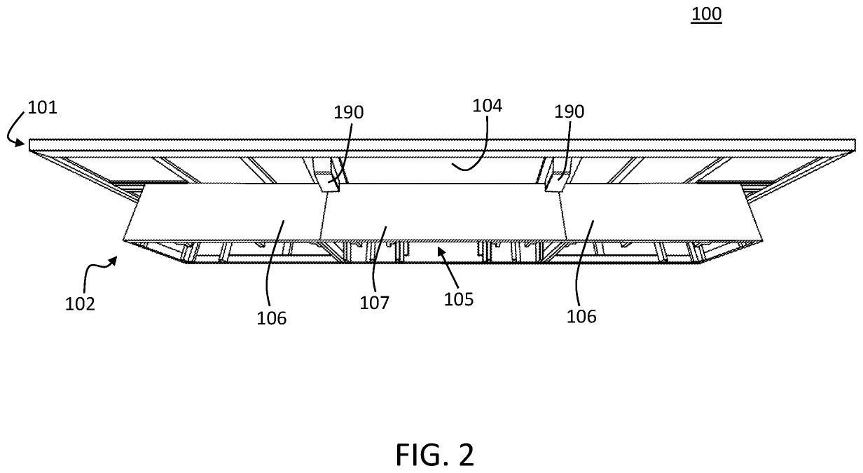

FIGS. 1 and 2 show, respectively, top and bottom perspective views of an exemplary air-circulating conference table 100 according to the present disclosure. While a conference table designed to accommodate multiple users (e.g., seated across from and/or next to each other around the table) is shown for illustrative purposes, a smaller table or table-like structures (e.g., a podium) designed to accommodate a single individual also falls within the scope of the present disclosure.

Referring to FIGS. 1 and 2, the table 100 includes a table top 101 and a table base 102. The table top 101 can define a working surface 103, which can generally be a flat and smooth surface that a user can work on. In some cases, an antimicrobial coating or layer can be applied to all or a part of the working surface to provide additional protection from, for example, bacterial and fungal growth on the working surface. The table top 101 as shown is rectangular in shape and designed to seat six users (e.g., three on each long edge of the table), but tables of various other shapes and/or sizes can be used to accommodate different numbers of users.

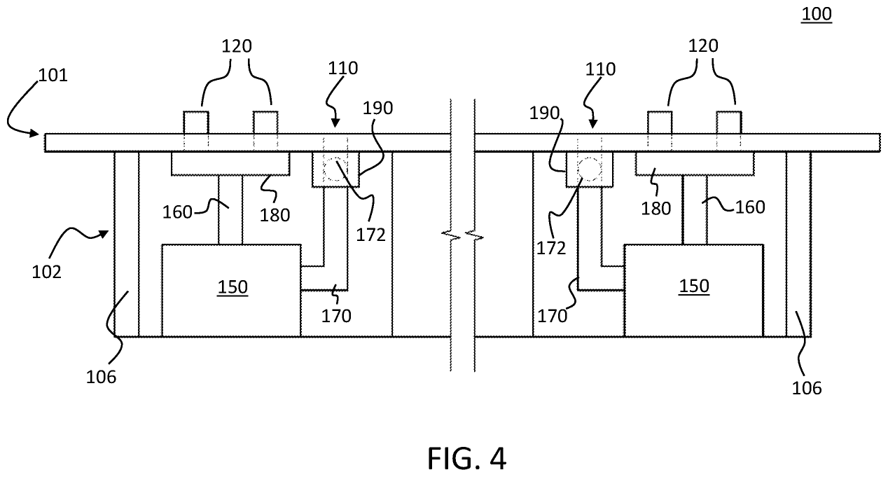

The table base 102 is provided below the table top 101 and can hold up and support the table top 101. For example, the table base 102 can be coupled to an underside 104 of the table top 101. The table 102, as shown in FIG. 2, can include one or more side panels that form the external wall of the table base 102. The side panels can include one or more fixed panels 106 and/or one or more removable panels 107. The table base 102 can define an interior space 105. The interior space 105 can be defined, for instance, by the one or more side panels 106, 107. The interior space 105 is designed to house one or more air filtration units 150 (FIG. 4). As seen in FIG. 2, the interior of the table base 102 can include various support structures, such as beams and columns, that provide structural support for the table top 101, air filtration unit 150, and/or the side panels 106, 107.

While the table base 102 shown in FIG. 2 has a rectangular shape, various other shapes can be used. The table base 102 is typically sized to have a smaller footprint than the table top 101 such that sufficient leg room is provided under the table top 101 for users of the table. The table top 101 and the table base 102 can be made from various materials including one or more of wood, plastic, metal, composites, or any other suitable material. The table base 102, in particular the side panels, can include soundproofing materials, such as foam, rubber, or the like, to help reduce noise and/or vibration generated by the air filtration unit.

Referring back to FIG. 1, the table top 101 can include various air inlets and air outlets that send and receive air, respectively, to and from the one or more air filtration units provided within the table base 102. For example, the table top 101 can include air inlets in the form of edge vents 110 provided along the edge portion of the table and/or center vents 112 provided along the center portion of the table. These inlets can receive air from above the table top 101 and send them below the table top 101 to the one or more air filtration units in the table base 102. Various types of vents, openings, inlets, and the like can be used to from the inlets 110, 112. For example, the edge vents 110 can include one or more slits that are recessed into the working surface 103 to provide a smooth and integrated appearance with the working surface 103. Meshes, grilles, or other types of barriers can be provided within the slits to help prevent foreign objects from falling through. Similarly, the central vents 112 can include louvers or grills to help prevent foreign objects from passing through.

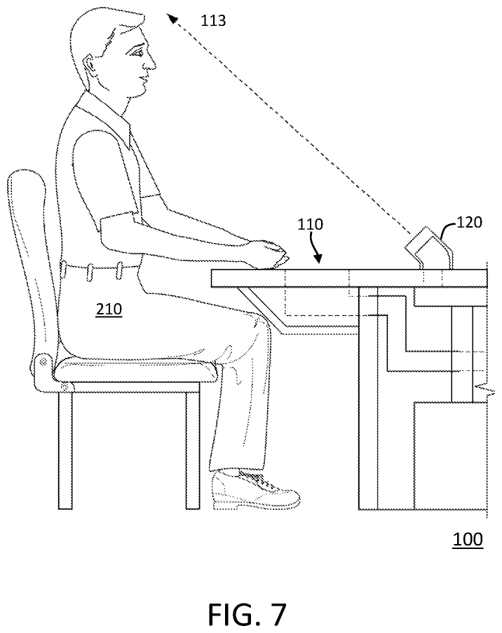

The table top 101 can also include one or more air outlets 112 that are designed to blow the filtered air from the one or more filtration units to above the table top 101. In some cases, referring also to FIG. 7, all or some of the air outlets 112 are designed to output the filtered air at a vertically inclined direction 113 with respect to the working surface 103. For example, filtered air can be discharged from the air outlet 112 at an incline angle of between 30 to 60 degrees relative to the working surface. For example, the incline angle can be around 45 degrees. In some cases, the incline angle can be adjusted based on the height and/or position of the user seated or standing at the table. In some cases, the direction 113 of the discharged filtered air may be aimed at around 3 inches above the head of a user 210 who is using the table. In some cases, the direction 113 may be aimed to be between 0 and 3 inches above the head of the user 210. In some cases, the discharged air may be directly aimed at a facial region of the user standing or sitting at the table. As discussed further below, aiming the discharged filtered air in this manner can help create a high-pressure area of clean, filtered air around the facial region of the user. This can help prevent, for instance, dirty or otherwise unfiltered air from being breathed by the user.

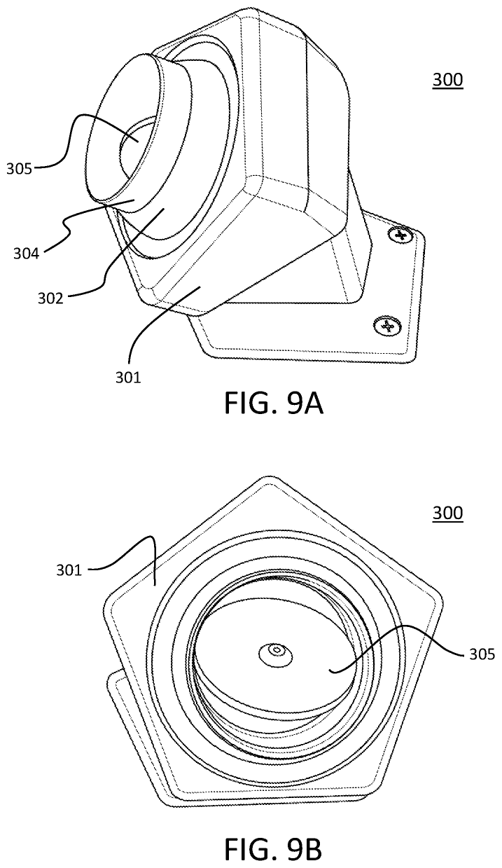

In some implementations, as shown in FIGS. 4-7, the air outlets 112 can be in the form of nozzles that protrude vertically upward from the working surface 103. For example, the air outlets may protrude a distance of 2-3 inches above the flat working surface. In some cases, the outlets 120 may include an adjustable diffuser such that the angle of output of the filtered air from outlet 120 as well as, in some cases, the flow volume of the discharged air can be modified during use. An example of such an adjustable diffuser can be seen in FIGS. 9A and 9B.

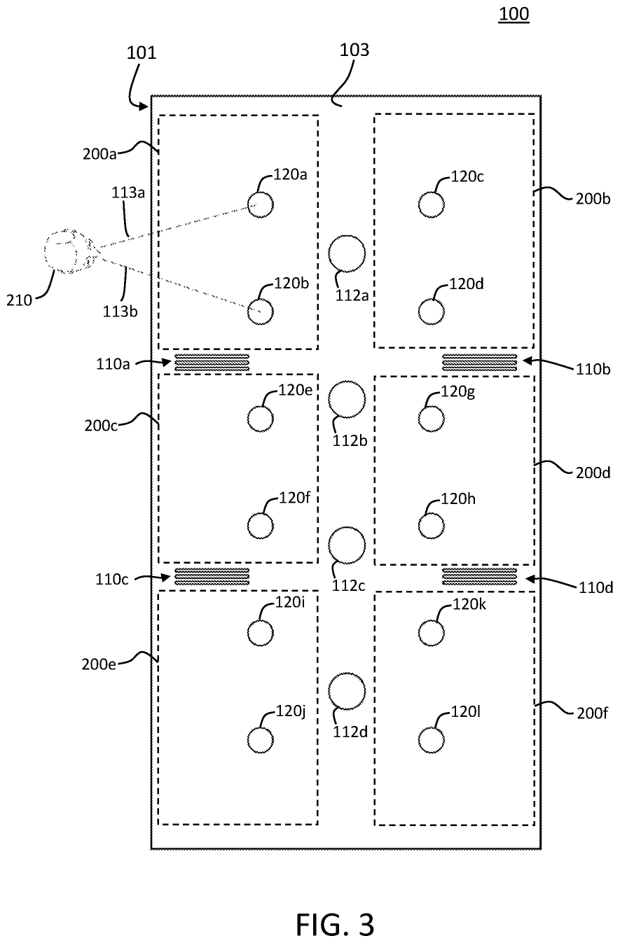

Referring to FIG. 3, a top-down view of the table 100 is shown, with each of the exemplary inlets 110, 112 and outlets 120 from FIG. 1 identified separately (i.e., edge vents 110a-d, center vents 112a-d, and outlet nozzles 120a-1) for purposes of illustration. Working areas 200a-200f are also indicated on FIG. 3. Each working area corresponds to a hypothetical area of clean/filtered air that is meant to support one of the users sitting/standing at the table. Such working areas can help minimize the cross-contamination of air among different users of the table Accordingly, each working area can be associated with a unique group of air outlets 120 to provide a dedicated stream of clean air to the user associated with that working area. For instance, user 210 that is seated at the working area 200a can receive clean/filtered air from air outlets 120a and 120b. Similarly, a user seated at the working area 200b can receive clean/filtered air from air outlets 120c and 120d. A user seated at the working area 200c can receive clean/filtered air from air outlets 120e and 120f. A user seated at the working area 200d can receive clean/filtered air from air outlets 120g and 120h. A user seated at the working area 200e can receive clean/filtered air from air outlets 120i and 120j. A user seated at the working area 200f can receive clean/filtered air from air outlets 120k and 120l.

As shown, air can be discharged from the air outlets 120c and 120d along flow directions 113a and 113b, respectively, which can be aimed at a facial region of the user 210 in a laterally converging manner. Other users seated at other working areas can similarly receive clean/filtered air from the corresponding designated air outlets. While just one example configuration has been shown in FIG. 3 for illustrative purposes, other arrangements are also possible. In some cases, the flow directions 113a and 113b may be parallel to each other.

Each working area can also be associated with one or more air inlets 110, 112. For example, referring again to FIG. 3, the working area 200a can be associated, for instance, with edge vents 110a and center vents 112a. Similarly, the working area 200b can be associated with edge vents 110b and center vents 112a. The working area 200c can be associated with center vents 112b and 112c. The working area 200d can also be associated with center vents 112b and 112c. The working area 200e can be associated with edge vents 110c and center vents 112d. The working area 200f can be associated with edge vents 110d and center vents 112d. While just one example configuration has been shown in FIG. 3 for illustrative purposes, other arrangements are also possible. For example, in some implementations, one or two edge vents can be provided laterally to each working area.

Air inlets and outlets that are referred to as being associated with a common working area refer to air inlets/outlets that are connected to a common air filtration unit provided below the table top. For example, for working area 200a, return air can be received through inlets 110a and 112a, be filtered through an air filtration unit 150 (see FIG. 4) that is provided for that working area, and be discharged through the outlets 120a and 120b. Working areas positioned at opposing sides of the table, such as working areas 200a and 200b, can both be associated with a single air filtration unit that can be housed within the table base at a lateral position between the two working areas. Providing a common air filtration unit between opposing working areas in this manner can help reduce the amount of duct work and/or space required to receive/filter/discharge air from above the table top. This can help, for instance, minimize the footprint of the table base and thus maximize leg space for the user of the table.

As shown in the example illustrated in FIG. 3, adjacent working areas can have one or more air inlets provided between them. For example, working areas 200a and 200c have edge vents 110a provided between them, and working areas 200c and 200d have center vents 112b and 112c provided between them. As explained further below, these inlets provided between working areas can help create a region of negative air pressure that acts to draw away dirty/contaminated/unfiltered air away from the working areas and toward the air filtration unit provided within the table base.

Although FIG. 3 illustrates a table having a certain number of inlets 110, 112 and outlets 120 provided at a rectangular table designed to accommodate six users, implementations of the present disclosure can include any tables having any number of inlets an outlets. For example, in some cases, the table 100 may include only one inlet and one outlet and may be configured for a single individual (e.g., a podium). Accordingly, it is to be understood that tables of any shape, size, or configuration with respect to the number of inlets, outlets, and air-filtration units, fall within the scope of the present disclosure

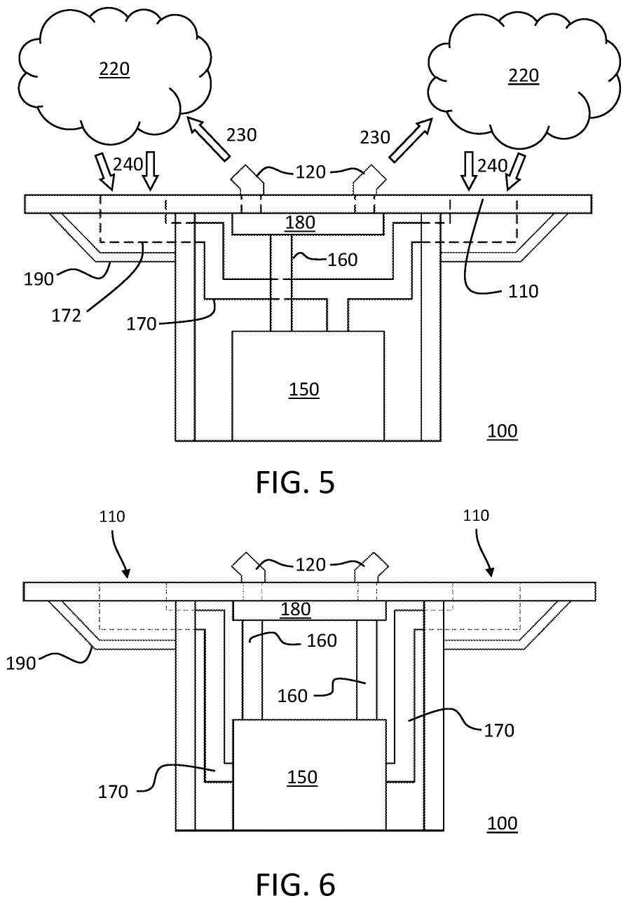

Referring to FIGS. 4-5, the exemplary air-circulating conference table 100 may include at least one air filtration unit 150 that can be mounted or otherwise provided within the interior space 105 of the table base 102. In some cases, two or more air filtration units 150 may be provided, for example, one for each pair of opposing working areas as shown in FIG. 3. The air filtration unit can include a housing that defines an intake and an exhaust, a fan, and a filter. The filter can include a high efficiency particulate air (HEPA) filter. In some cases, HEPA filters rated at H13 or higher can be used to help filter out viruses, including COVID-19. Other types of air filtration units for purifying air is contemplated within the present disclosure.

As shown, the table 100 can include a plurality of ducts that provide fluid connections between the air filtration unit 150 disposed in the table base 102 and the various inlets and outlets provided at the working surface of the table top 101. For example, the plurality of ducts can include an exhaust duct 160 that connects an exhaust of the air filtration unit 150 to the one or more air outlets 120. The plurality of ducts can also include an intake duct 170 that connects an intake of the air filtration unit 150 to the one or more air inlets 110 (and also 112 if available).

A duct as used herein may be made of any metal, plastic, composite, or any other material suitable for facilitating the flow of air from inlets 110, 112 to the air filtration unit 150 and from the air filtration unit 150 to the outlets 120. In some cases, the duct may be made from aluminum or polyvinyl chloride (PVC). In some cases, the duct may be rigid or flexible. In some implementations, the table 100 can include a plenum 180. The plenum 180 may be positioned underneath the table top 101 and may be configured to facilitate the output of filtered air through the various outlets 120. Additionally, the plenum 180 can help ensure a consistent discharge of filtered air across the various outlets 120 connected to it. For example, air outlets 120a-d shown in FIG. 3 may be connected to a first plenum that is connected to a first air filtration unit. Similarly, air outlets 120e-h may be connected to a second plenum that is connected to a second air filtration unit. The air outlets 120i-l may be connected to a third plenum that is connected to a third air filtration unit.

In some cases, additional germicidal/purification systems may be provided within the duct work in the table base 102. For example, an ultraviolet (UV) light source may be provided within the plenum 180 to further disinfect/clean the air received in the plenum. In some implementations, as shown in FIG. 5, additional intake and/or exhaust ducts may be provided to the air filtration unit.

Referring further to FIG. 2, the intake duct 170 can include an end portion 172 that extends outward to beyond a lateral boundary of the table base 102. For example, as illustrated in FIGS. 4-5, the end portion 172 can extend laterally outward beyond the walls of the table base 102 before being directed upward to connect to the edge vents 110.

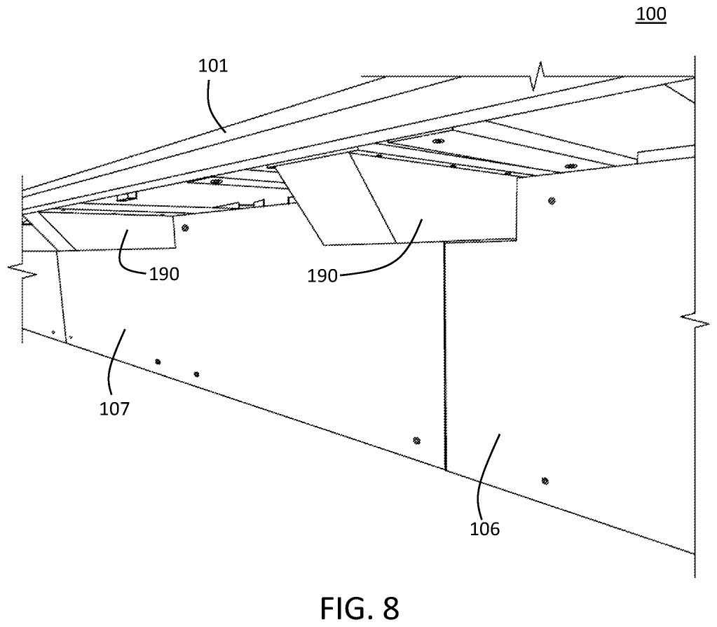

In some implementations, as illustrated in FIGS. 4-6, the end portion 172 can be housed within a duct housing 190 that extends laterally outward from the table base and also protrudes vertically downward from a bottom surface of the table top. As seen in FIG. 8, the duct housing 190 can help hide unsightly ducts from being visible while helping to maximize left space for the user by allowing the table top 101 to maintain a slim profile. The duct housing can be made from same or similar materials as the table top 101 or the table base 102 to help contribute to a seamless, integrated appearance. As shown in FIGS. 5 and 8, an inwardly sloping outer surface of the duct housing can also provide a slimming effect by minimizing the amount of the duct housing that can be seen by the user.

Referring back to FIG. 3, the duct housing 190 can be provided underneath the table top 101 at locations corresponding to the edge vents 110. Thus, intake ducts connected to the edge vents 110 can be hidden from view while maximizing the amount of leg room (i.e., under table space) that is available to the user.

Other implementations may include ducts that are arranged in a variety of different configurations with respect to the number of inlets, outlets, and air filtration units. For example, FIG. 6 illustrates a cross-sectional side view of another exemplary duct configuration where multiple exhaust ducts 160 as well as multiple intake ducts 170 are provided for a single air filtration unit 150. Accordingly, the object of the present disclosure may be achieved through any number, combinations, and configurations of inlets, outlets, air filtration units, ducts, split ducts, and/or plenums, each of which fall within the scope of the present disclosure

Referring now to FIG. 5, an example of a positive pressure zone 220 that can be formed around a facial region of the user is illustrated. For example, by discharging clean air 230 through via outlets 120 toward the facial region and at the same time suctioning return air 240 via the inlets 110 (and also 112 if available), the positive pressure zone 220 can be formed, with the negative air pressure created at the inlets via the intake action helping to draw any dirty/contaminated air away from the facial region of the user. Accordingly, dirty/contaminated air that happens to enter the facial region of the user, for instance by a person who is walking by the user, can be directed away from the facial region by the positive pressure and toward the inlets/vents.

FIGS. 9A and 9B show an example outlet nozzle 300 that can be used, for instance, as an outlet nozzle 120. The outlet nozzle 300, for instance, can be an eyeball-type swivel nozzle that can direct the filtered air being discharged along a wide range of varying angles along the vertical and horizontal axes. The outlet nozzle 300 can include a housing 301 and a circular portion 302 that can swivel relative to the housing. The outlet nozzle 300 can also include a flow control rim 304 that can be rotated by the user to control the amount of opening that is provided by a flap 305. Opening up the flap 305 completely can allow a maximum flow output to be discharged through the nozzle. Closing up the flap 305 completely can block the flow.

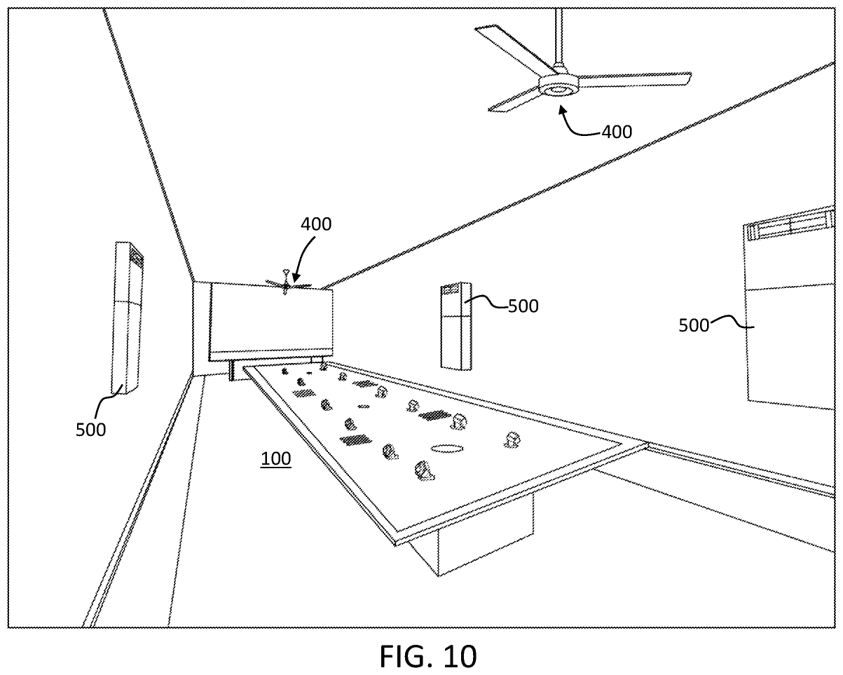

Referring to FIG. 10, an example conference room having the table 100 is shown. In some cases, ceiling fans 400 may be provided at either ends of the table 100 to provide additional airflow, which can help provide an additional area of negative pressure around the table to further drive dirty/unfiltered air away from the table and its users. One or more wall-mounted air filtration units 500 can further help drive dirty/unfiltered air away from the table and its users.

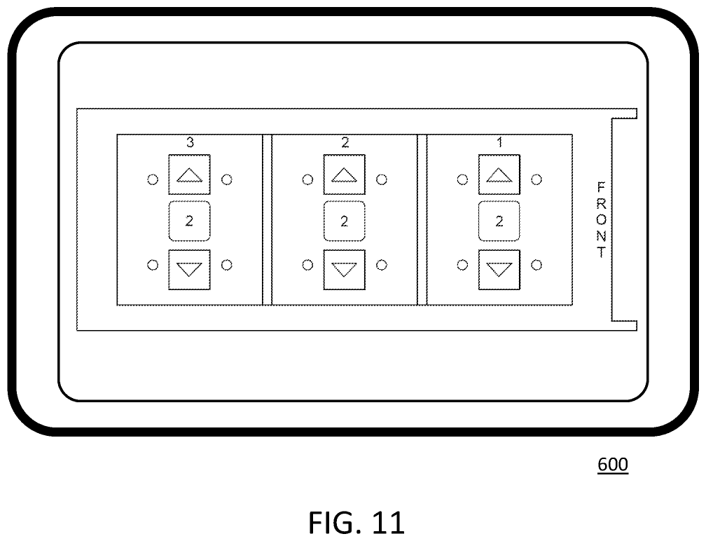

An exemplary user interface 600 for controlling the air-circulating table 100 is shown in FIG. 11. The interface 600 can be a standalone unit, such as a tablet, and/or may be integrated with the table 100. As illustrated, fan speeds of each of the air filtration units associated with the three control zones can be individually controlled by toggling up/down on the arrow icons. For illustrative purposes, with reference to FIG. 3, control zone 1 may be associated with working areas 200e and 200f, control zone 2 may be associated with working areas 200c and 200d, and control zone 3 may be associated with working areas 200a and 200b.

It is to be understood that the dimensions, configurations, and specifications of the different elements of disclosed embodiments may be adjusted to accomplish different needs, requirements, and standards. For example, by way of adjusting power levels of the air-filtration unit, dimensions of the ducts, inlets, and outlets, or by adjusting any other specification of the table, an air-circulating conference table can be configured to recirculate air in a room at a higher rate (e.g., all air in a room may be recirculated every 6 minutes), a lower rate, or any rate based on preference, standards, regulations, or for any other reason.

While the present disclosure is described herein with reference to illustrative embodiments of devices used for particular applications, such as an air-circulating conference table, it should be understood that the embodiments described herein are not limited thereto. Those having ordinary skill in the art and access to the teachings provided herein will recognize additional modifications, applications, embodiments, and substitution of equivalents that all fall within the scope of the disclosed embodiments. Accordingly, the disclosed embodiments are not to be considered as limited by the foregoing or following descriptions.

The many features and advantages of the present disclosure are apparent from the detailed specification, and thus it is intended by the appended claims to cover all such features and advantages of the present disclosure that fall within the true spirit and scope of the present disclosure. For example, although exemplary embodiments are described with reference to an air-circulating conference table, it is to be understood that disclosed embodiments may include other types of tables and/or surfaces. Further, since numerous modifications and variations will readily occur to those skilled in the art, it is not desired to limit the present disclosure to the exact construction and operation illustrated and described and accordingly, all suitable modifications and equivalents may be resorted to, falling within the scope of the present disclosure.

Moreover, those skilled in the art will appreciate that the conception upon which this disclosure is based may readily be used as a basis for designing other structures, methods, and systems for carrying out the several purposes of the present disclosure. Accordingly, the claims are not to be considered as limited by the foregoing description.

What is claimed is:

1. A table for providing filtered air, comprising
a table top defining a flat working surface, the table top including (i) one or more air outlet nozzles that are disposed at the working surface and configured to discharge air in an upward direction and (ii) one or more air inlet vents that are disposed at the working surface and configured to receive air in a downward direction;
a table base provided vertically below the table top and defining an interior space therein; and
at least one air filtration unit disposed in the interior space of the table base, the air filtration unit being configured to receive return air from the one or more air inlet vents and to discharge filtered air via the one or more air outlet nozzles.

2. The table of claim 1, further comprising a plurality of ducts in the interior space of the table base that provide fluid connection from the at least one air filtration unit to the one or more air outlet nozzles and to the one or more air inlet vents.

3. The table of claim 2, wherein the plurality of ducts include an exhaust duct that connects an exhaust of the at least one air filtration unit to the one or more air outlet nozzles and an intake duct that connects an intake of the at least one air filtration unit to the one or more air inlet vents.

4. The table of claim 3, wherein the one or more air inlet vents include one or more edge vents that are disposed closer to an edge region of the table than the one or more air outlet nozzles, the one or more edge vents being positioned laterally outward beyond a lateral boundary of the table base.

5. The table of claim 4, wherein the intake duct includes an end portion that connects to the one or more edge vents, the end portion of the intake duct extending beyond the lateral boundary of the table base.

6. The table of claim of claim 5, further comprising at least one duct housing that extends laterally outward from the table base and protrudes vertically downward from a bottom surface of the table top, each of the at least one duct housing defining an interior space that houses the end portion of the intake duct.

7. The table of claim 6, wherein the table includes at least two adjacent working areas for accommodating two adjacently seated users, and wherein the at least one duct housing is provided between the at least two adjacent working areas.

8. The table of claim 6, wherein a laterally outermost surface of the at least one duct housing is inclined downward toward the table base.

9. The table of claim 1, wherein the at least one air filtration unit includes a fan and a filter.

10. The table of claim 9, wherein the filter includes a high-efficiency particulate air (HEPA) filter.

11. The table of claim 1, wherein the interior space of the table base is at least partially defined by a bottom surface of the table top and an external wall of the table base.

12. The table of claim 11, wherein the external wall includes one or more side panels.

13. The table of claim 12, wherein at least one of the one or more side panels is an access panel that is configured to be removed to thereby allow access to the at least one air filtration unit housed in the interior space.

14. The table of claim 3, wherein the exhaust duct connects the exhaust of the at least one air filtration unit to a plenum that is provided in the interior space of the table base, the plenum being configured to direct the filtered air received from the exhaust duct to the one or more air outlet nozzles.

15. The table of claim 14, further comprising an ultraviolet (UV) light source configured to disinfect the air received in the plenum.

16. The table of claim 14, wherein the plenum is disposed between a bottom surface of the table top and a top surface of the at least one air filtration unit.

17. The table of claim 14, wherein the plenum is connected to two or more air outlet nozzles via additional ducts.

18. The table of claim 4, wherein the one or more air inlet vents include one or more center vents that are disposed farther from the edge region of the table than the one or more air outlet nozzles, and wherein the intake duct includes a first intake duct that connects the intake of the at least one air filtration unit to the one or more air inlet vents and a second intake duct that connects the intake of the at least one air filtration unit to the one or more center vents.

19. The table of claim 1, wherein the one or more air outlet nozzles are configured to output the filtered air in a direction that is vertically inclined with respect to the working surface.

20. The table of claim 1, wherein the table includes at least two oppositely disposed working areas for accommodating two users seated on opposite sides of the table, wherein each of the at least two adjacent working areas includes at least one of the one or more air outlet nozzles, and wherein the at least one air filtration unit is disposed between the at least two oppositely disposed working areas.
